(19) United States
(12) Patent Application Publication
(10) Pub. No.: US 2015/0382171 A1
(43) Pub. Date: Dec. 31, 2015

(54) LONG-RANGE DEVICE DISCOVERY WITH DIRECTIONAL TRANSMISSIONS

(71) Applicant: INTERDIGITAL PATENT HOLDINGS, INC., Wilmington, DE (US)

(72) Inventors: Arnab ROY, East Norriton, PA (US); Yugeswar DEENOO, King of Prussia, PA (US); Philip J. PIETRASKI, Jericho, NY (US); Ravikumar V. PRAGADA, Collegeville, PA (US); Onur SAHIN, Brooklyn, NY (US)

(73) Assignee: InterDigital Patent Holdings, Inc., Wilmington, DE (US)

(21) Appl. No.: 14/766,698

(22) PCT Filed: Feb. 7, 2014
(86) PCT No.: PCT/US2014/015273

§ 371 Date: Aug. 7, 2015

Related U.S. Application Data
(60) Provisional application No. 61/762,127, filed on Feb. 7, 2013.
(60) Provisional application No. 61/874,800, filed on Sep. 6, 2013.

(51) Int. Cl. H04W 8/00; H04Q 3/08; H04W 40/24; H04W 48/16

(52) U.S. Cl. CPC H04W 8/005; H04W 48/16; H04Q 3/08; H04W 40/244

(57) ABSTRACT

Device discovery at long ranges using directional antenna patterns for both transmission and reception of discovery beacon messages and discovery beacon response messages. Omnidirectional band transmissions to assist aiming a directional antenna are also described. Further, discovery beacons that include only those information elements which are necessary for device discovery are discussed, as well as separate scheduling beacons. The discovery beacon may include more robust encoding to increase discovery range or may be transmitted using a narrower channel to improve signal to noise ratio.

### CROSS REFERENCE TO RELATED APPLICATIONS

This application claims the benefit of U.S. Provisional Application Ser. No. 61/762,127, filed Feb. 7, 2013, and U.S. Provisional Application Ser. No. 61/874,800, filed Sep. 6, 2013, the contents of which are hereby incorporated by reference herein.

### BACKGROUND

The millimeter wave (mmW) frequency band provides a huge amount of spectrum. In the United States of America, the 60 GHz unlicensed spectrum encompasses a range of about 7 GHz (this range varies by country) and much more spectrum may potentially become available as licensed, lightly licensed, or unlicensed spectrum. In order to close the link budget for mmW applications, highly directional antennas are required, and are becoming practical (e.g. Wireless HD devices). Higher frequencies, such as in the mmW band, have the potential to allow much greater spatial reuse; a synergistic effect that is diminished at lower frequencies and is effectively not possible below 6 GHz. Furthermore, the higher gain antennas that are used for millimeter wave communications have greater directionality, which can reduce interference as seen by unintended receivers. At mmW frequencies, large carrier bandwidths (BWs) are achievable with comparatively low fractional BWs. This can enable single radio solutions capable of addressing large amounts of spectrum. Utilizing mmW frequencies can also lead to lower power consumption by the use of highly directional antennas and by trading bandwidth for power (Shannon's law).

The mmW carriers have near optical properties with high penetration losses, high reflection losses, and little diffraction; leading to line of sight (LOS) dominated coverage. Millimeter wave frequencies are also subject to a host of propagation challenges, including high oxygen absorption for the 60 GHz band.

The IEEE 802.11ad standard, which uses the 60 GHz band, suffers from a device discovery range that is shorter than its associated communication ranges. In other words, IEEE 802.11ad devices are capable of communicating via that standard over greater distances than the distance over which they are capable of discovering one another via that standard. This limited device discovery range is due to the quasi-omnidirectional (and consequently low gain) antenna pattern with which devices seeking to become new nodes in the network, including Stations (STAs), scan for beacon transmissions. Although 802.11ad access points (APs) transmit beacons with a sectorized (i.e. directional, high-gain) antenna pattern, the combined antenna gain is smaller than that used during data communications that follow mutual beam refinement.

Other limitations of the IEEE 802.11ad standard result from the transmission of beacon messages that are essentially the same in different directions, differing only in sector identification and timestamp values. Each of these beacon messages includes channel reservation schedules for all associated STAs in each beacon. This lengthy message is repeated in every sector regardless of the relative position of the STAs. Another limitation of the IEEE 802.11ad standard is that all communications under the standard are confined to the mmW channel.

### SUMMARY

Several procedures for long-range device discovery with directional transmissions are described. These include directional reception of discovery beacons and discovery beacon responses, using omnidirectional band transmissions to assist aiming a directional antenna, using separate discovery and scheduling beacons, where the discovery beacon includes only those information elements that are necessary for device discovery, and using a directional antenna for beacon reception and response transmission. The discovery beacon may include more robust encoding to increase discovery range or may be transmitted using a narrower channel to improve signal to noise ratio. It will be clear that these procedures may be used separately or in combination as appropriate.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 illustrates an IEEE 802.11ad device discovery procedure;

FIG. 3 illustrates paired beacon transmission and response slots;

FIG. 4 illustrates a frame structure for paired beacon transmission and response slots;

FIG. 5 illustrates unpaired beacon transmission and response slots;

FIG. 6 illustrates a frame structure for unpaired beacon transmission and response slots;

FIGS. 7A-7D illustrate example beam patterns for a responder using variable responder beamwidth discovery;

FIGS. 8A-8B illustrate illustrates beacon transmission focusing based on STA/Responder location information;

FIGS. 9A-9E illustrate a frame structure and beam configurations for transmission focusing;

FIG. 10 illustrates the contents of a current 802.11ad beacon and proposed discovery and scheduling beacons;

FIG. 11 illustrates the format of a current 802.11ad beacon and a proposed discovery beacon;

FIG. 12 illustrates a directional mesh network device discovery procedure;

FIG. 13 illustrates a message sequence for handling a device discovery error condition;

FIG. 14 illustrates a message sequence for handling another device discovery error condition;

FIGS. 15A and 15B illustrates a message sequence for handling another device discovery error condition;

FIG. 16 is a flow-chart illustrating an example device discovery phase at an initiating mesh node; and

FIG. 17 is a flow-chart illustrating an example device discovery phase at a responding new node.

### DETAILED DESCRIPTION

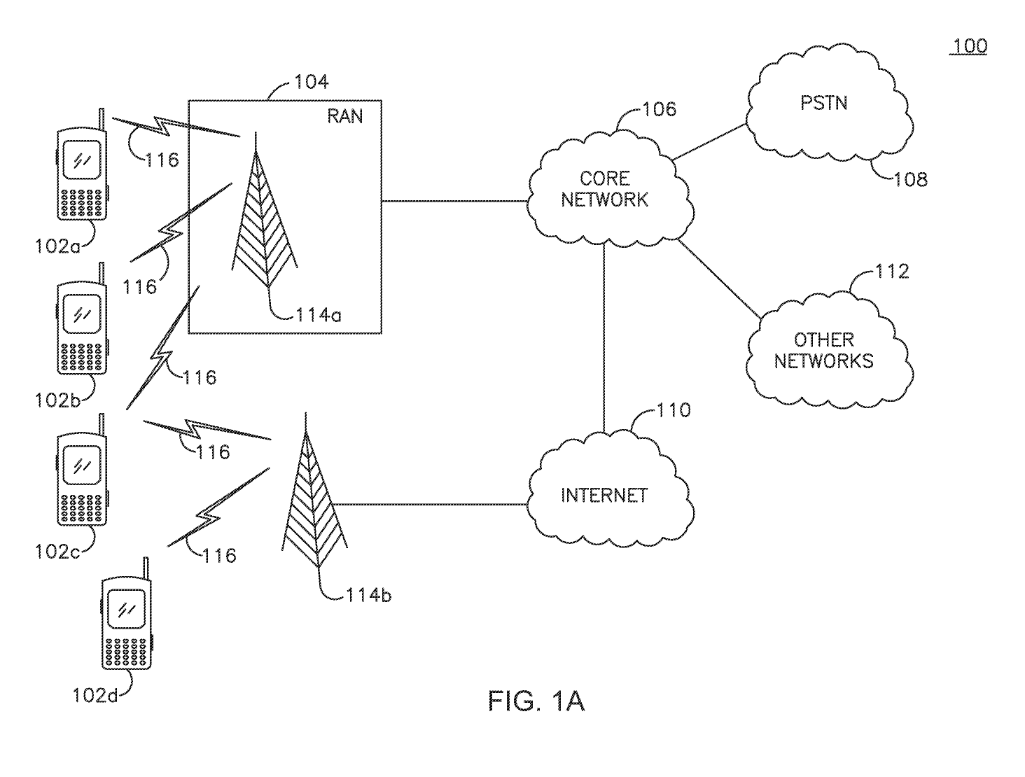

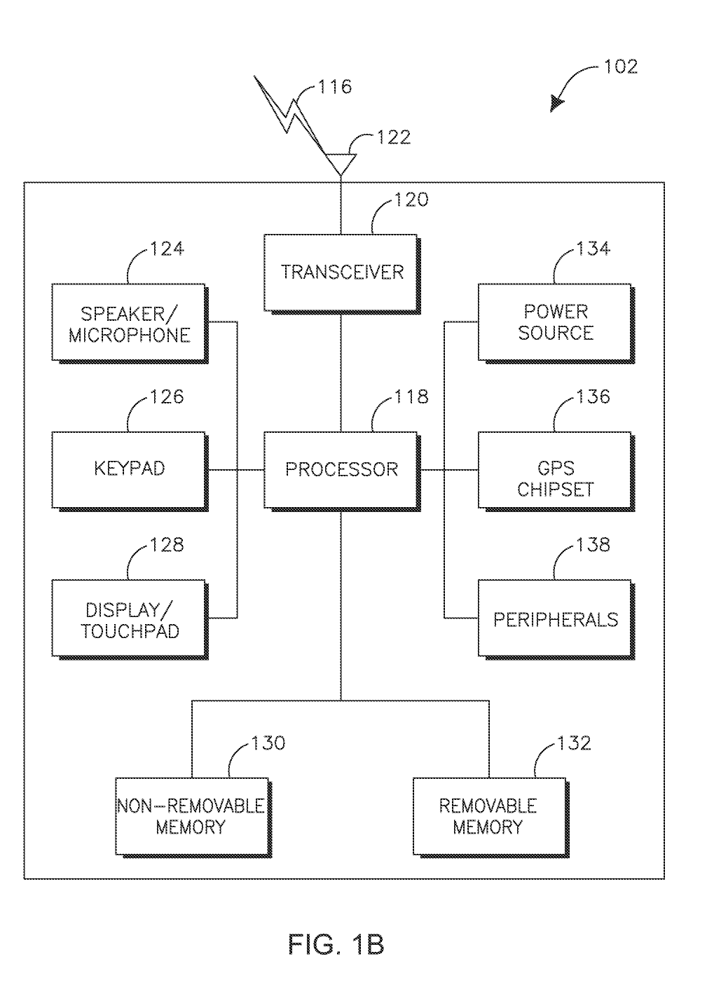

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, mmW frequencies, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Other networks 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

Several example procedures for long-range device discovery using directional transmissions are described herein. These include directional reception of discovery beacons and discovery beacon responses, directional reception assisted by omnidirectional band transmissions, reduced size discovery beacons which include only those information elements that are necessary for device discovery, and beacon reception and response transmission using a directional antenna. Further procedures include more robustly encoding a discovery beacon in order to increase the discovery range, and using a narrower channel to transmit the discovery beacon in order to improve signal-to-noise ratio (SNR). It will be clear that these procedures may be used separately or in combination as appropriate. Furthermore, although these techniques are discussed herein with respect to the IEEE 802.11ad standard, it will be understood that they are broadly applicable and not limited to use with IEEE 802.11ad compliant devices.

In IEEE 802.11ad based devices, device discovery occurs after an initiator transmits a beacon using a sectorized (i.e. directional) antenna pattern where the beacon is received by a responder using a quasi-omnidirectional antenna pattern, followed by a response transmission by the responder using a sectorized antenna pattern where the response is received by the initiator using a quasi-omnidirectional antenna pattern. Communications then proceed using sectorized antenna patterns for both transmission and reception.

Because the combined gain of the antenna patterns used during the discovery sequence is lower than the combined antenna gain of the antenna patterns used during subsequent communications, the device discovery range in present IEEE 802.11ad communications is smaller than the communications range.

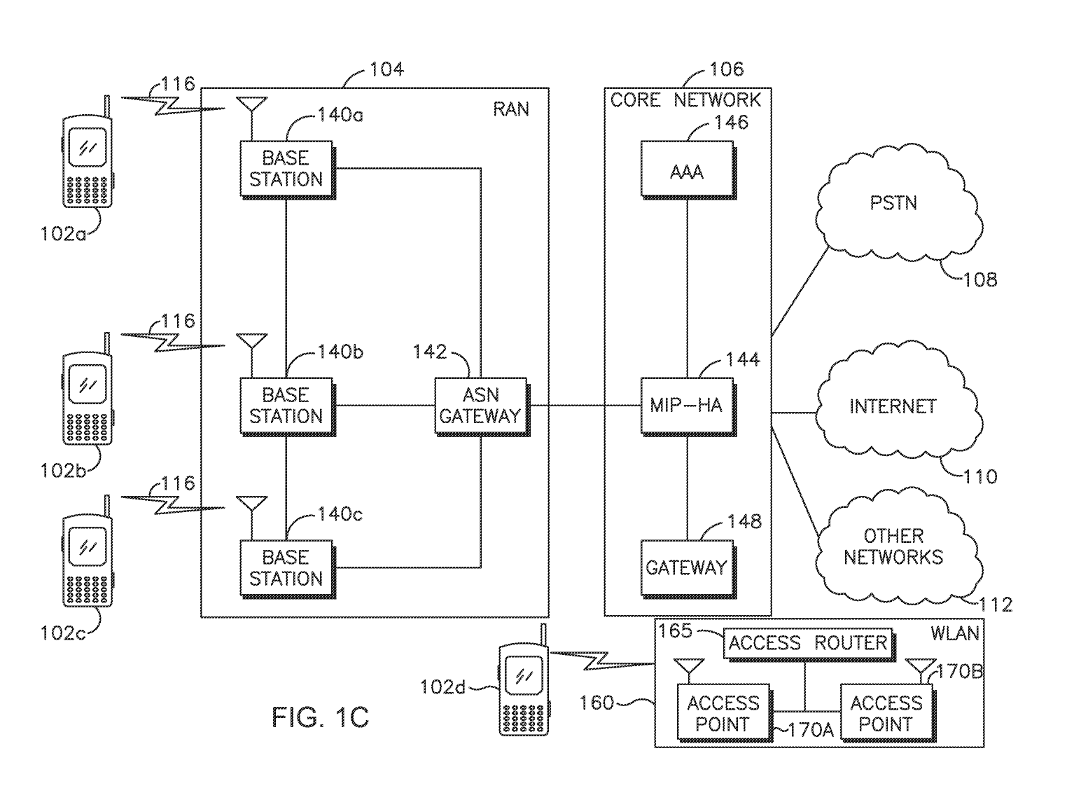

FIG. 2 illustrates an IEEE 802.11ad device discovery procedure.

In this example, the initiating node is a wireless AP 200 transmitting a discovery beacon in a beam pattern using a directional antenna. Throughout this disclosure an AP is frequently used as an example of an initiating node for discovery purposes. However it will be understood that other types of initiators may be used with the techniques and devices described herein, regardless of the type of initiator used in a given example.

Referring first to stage 1 205, AP 200 transmits the beacon via successive directional beams covering each of sectors 220a, 220b, 220c, 220d, and 220e, as shown in beam patterns 2a-2e. The responding node, STA 210, scans for discovery beacons using a quasi-omnidirectional pattern 230, as shown in beam patterns 2a-2e. Throughout this disclosure a STA is frequently used as an example of a responding node for discovery purposes, but it will be understood that other types of nodes may be used. As shown in beam patterns 2a-2e, the reception range of the quasi-omnidirectional pattern 230 is less than the transmission range of the directional beams 220a-220e.

Referring now to stage 2 215, upon receiving a beacon from AP 200, STA 210 transmits a discovery beacon response in a beam pattern using a directional antenna. STA 210 transmits the response via successive directional beams covering each of sectors 250f, 250g, 250h, 250i, and 250j, as shown in beam patterns 2f-2j.

AP node 200 scans for discovery beacon responses using a quasi-omnidirectional pattern 240, as shown in beam patterns 2f-2j. As shown in beam patterns 2f-2j, the reception range of the quasi-omnidirectional pattern 240 is less than the transmission range of the directional beams 250f-250j.

As further discussed herein, discovery range can be increased when a new node scans directionally for beacon transmissions, when an initiating node scans directionally for beacon responses, or both.

Example approaches for achieving increased discovery range using directional reception include using paired beacon transmission and response slots, using unpaired beacon transmission and response slots, and using variable directional responder receive beamwidth as further described below.

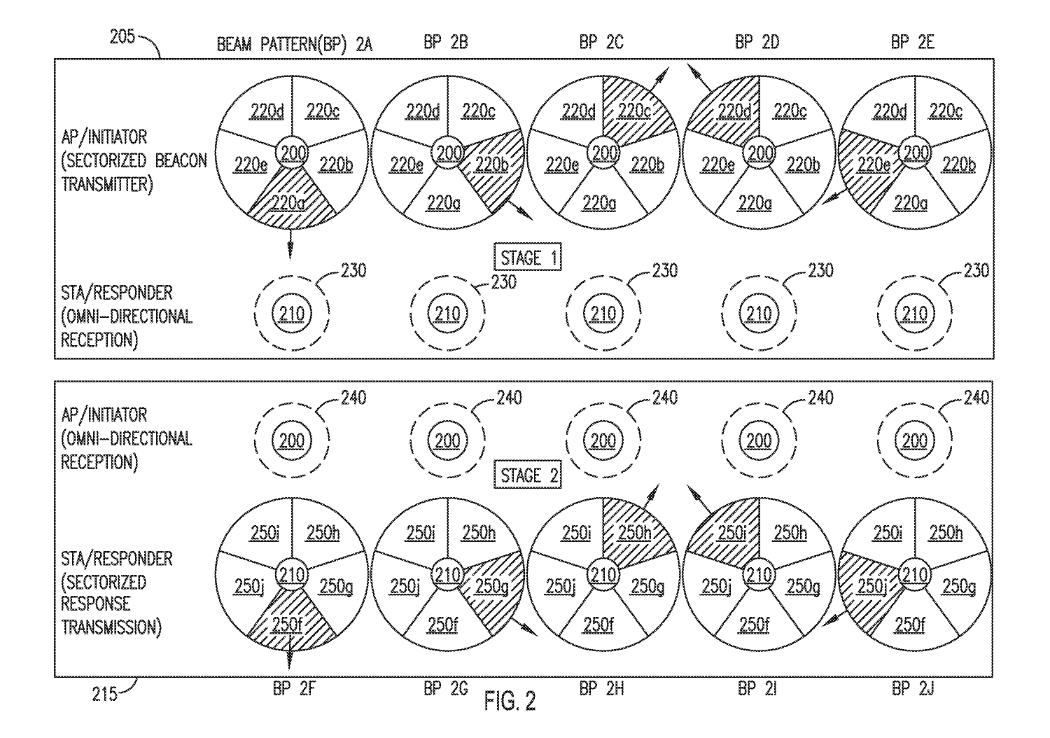

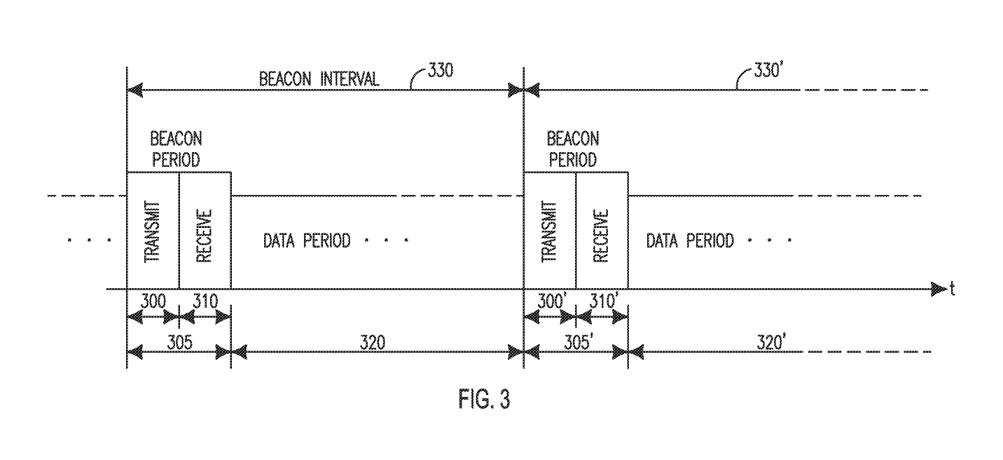

FIG. 3 illustrates a transmit-and-receive slot configuration for an AP where beacon response slots immediately follow beacon transmission slots. Using paired beacon transmission and response slots in this way, the AP/initiator repeats beacon transmissions in multiple directions during a beacon transmission interval. This is followed by an equal number of response slots in a beacon response reception interval, during which the AP switches over the same beam patterns, directionally scanning for beacon responses from any new nodes that may have received the beacons.

In this example, a beacon interval 330 includes a beacon period 305 and a data period 320. Beacon period 305 is divided between a beacon transmission period 300 and a beacon response reception period 310.

During beacon transmission period 300, the AP/initiator repeats directional beacon transmissions in M beacon slots (not shown), each covering a different direction. During beacon response reception period 310, the AP/initiator scans for responses to the beacon in each of M beacon response slots (not shown), which cover each direction of the M beacon slots respectively. Thereafter, the AP/initiator may proceed with transmitting and/or receiving data or other messages during a data period 320, which in this example continues for the remainder of beacon interval 330. The AP/initiator then enters another beacon transmission period 300′, response reception period 310′, and data period 320′, during another beacon interval 330′. This sequence repeats with a period of one beacon interval.

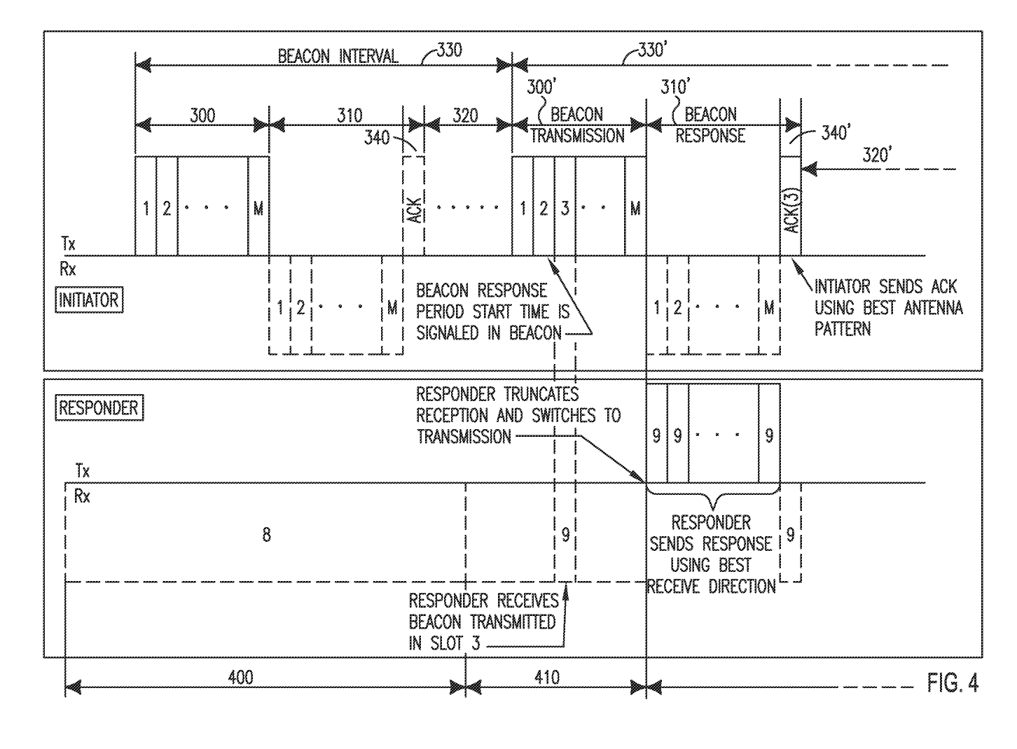

FIG. 4 illustrates an example frame structure for paired beacon transmission and response slots.

As discussed regarding FIG. 3, the AP/initiator repeats beacon transmissions in M slots during beacon transmission period 300, each using a different directional antenna beam pattern (beam) covering a different direction for transmission. During beacon response reception period 310, the AP/initiator scans for responses to the beacon in each of the M slots, each using a directional antenna beam pattern covering a different direction for reception. The order of the beams used for reception during beacon response reception period 310 is the same as the order of the beams used for transmission during beacon transmission period 300. During response reception period 310, an acknowledgement period 340 is provided for transmitting an acknowledgement of any received beacon response, and thereafter the AP/initiator may proceed with transmitting and/or receiving data or other messages during a data period 320, for the remainder of beacon interval 330.

Because no beacon response was received by the AP/initiator during reception period 310 in this example, no acknowledgement is transmitted by the AP/initiator during acknowledgement period 340. Although acknowledgement period 340 is illustrated as a part of beacon response period 310, in the case where no beacon response is received, acknowledgement period 340 may be used for other purposes and/or may be merged into data period 320.

Independently of the AP/initiator, the station (STA)/Responder scans for beacons in a particular receive direction during scan interval 400. At this time, the AP/initiator and STA/Responder are not synchronized. The STA/Responder dwells in a particular receive direction for the duration of a Beacon Directional Scan Interval (BDSI), before switching its receive beam to a different direction.

The length of a BDSI is defined as follows:

Beacon Directional Scan Interval=(Beacon Interval)*(Beacon Slot Recurrence Rate)+(Beacon Slot Duration)

Here, Beacon Slot Recurrence Rate is the number of beacon intervals required to complete a beacon transmission cycle covering all supported directions, and Beacon Slot Duration is the time required for one beacon transmission, using a particular antenna configuration.

A BDSI includes a Beacon Slot Duration in addition to the (Beacon Interval)*(Beacon Slot Recurrence Rate) to account for lack of initial synchronization between the initiator and responder. Since the responder scans for an extra beacon slot duration beyond the beacon repetition in each scan direction, beacon reception failure due to scan direction switch within a beacon slot may be avoided. This allows the responder to be discovered without initial frame synchronization. Since the responder switches receive direction every BDSI, the responder is assured of receiving a beacon in K*(Beacon Directional Scan Interval) duration, under ideal conditions and if within range for particular combined transmit and receive antenna gain, where K is the number of receive beams used by the responder.

In the example of FIG. 4, the STA/Responder scans for beacons in a particular direction, in this case using its beam designated as beam 8, for the duration of scan interval 400. Scan interval 400 equals one BDSI. The STA/Responder does not receive any beacons on beam 8 during scan interval 400, and proceeds to scan for beacons on beam 9 during subsequent scan interval 410. In this example, the STA/Responder receives a beacon from the AP/initiator while scanning beam 9 during scan interval 410. This received beacon was transmitted by the AP/initiator during its slot 3, and information identifying the beacon as having been transmitted during slot 3 (such as an identification of the time slot or beam used by the AP/initiator to transmit the beacon) may be provided to the STA/responder in the beacon.

During beacon response reception period 310′, the AP/initiator scans for responses to the beacon in each of M slots. A beacon response is received from the STA/responder during slot 3, when the AP/initiator is scanning in a direction in which it can receive the beacon response, i.e., with a beam pattern oriented sufficiently toward the STA/responder.

The AP/initiator may continue to scan the remaining slots during reception period 310′, and in some implementations may receive additional responses from other responders during those slots (not shown).

Each beacon may contain information about the start of the next beacon response period. In this case, if the STA/Responder successfully receives a beacon, it truncates its current directional scan at the start time of the next beacon response period of the AP/initiator, as provided by the beacon. The responder then sends the beacon response repeatedly using the beam that was used for successful beacon reception. The responder repeats the response M times, and these transmissions are synchronized with the receive slots at the initiator. As noted above, this slot synchronization is achieved due to information in the received beacon.

In the example of FIG. 4, the STA/responder receives a beacon transmitted by the AP/initiator during slot 3 of beacon transmission period 300′. The beacon contains information regarding the start time of beacon response period 310′. At the start time of beacon response period 310′, STA/responder truncates scan interval 410 (unless the start time of beacon response period 310′ coincides with the end of scan interval 410, in which case truncation is unnecessary) and sends a beacon response to the AP/initiator M times using an antenna beam in the direction in which the beacon was received, which in this case is direction “9” (i.e. beam 9).

In some implementations, the STA/responder may receive beam identifying information in the received beacon, and based on the beam identifying information, send the beacon response only when the initiator uses the same beam to scan for beacon responses.

The responder may predict when the initiator uses the same beam to scan for beacon responses. In implementations where, as in the example of FIG. 4, the transmit and receive beams at the AP/initiator follow the same sequence of directions within a beacon period, the STA/responder may predict when the initiator is receiving in a particular direction based simply on a beam (i.e. direction) identifier of the received beacon, and may transmit only at that time.

The STA/responder may include an identification of the AP/initiator beam on which the beacon was successfully received in its response to the AP/initiator. This response informs the initiator of the best beam seen by the responder. In addition, the initiator may implicitly learn the best beam on which to communicate with the responder based upon the slot in which the beacon response is successfully received. From the implicit and/or explicit feedback, the initiator may estimate any errors in transmit and receive beams. For example, it is possible that due to a mismatch in transmit and receive beams at the AP/initiator, the responder may measure a highest received signal strength as corresponding to the Beacon transmitter via AP/Initiator beam 9, but when the response from the STA/responder is received by the AP/initiator, the highest received signal strength corresponds to receive beam 10. Using a combination of implicit and explicit feedback allows the AP/initiator to use different transmit and receive beams for the same STA/responder or choose a single optimum beam based on some criteria. The initiator may then use the best beam learned from the received beacon response to send an acknowledgement to the responder, signaling successful discovery.

Having received the beacon response during beacon reception period 310′, the AP/initiator sends an acknowledgement to the STA/responder during acknowledgement period 340′. The acknowledgement is sent directionally using the beam on which it received the response, which in this case is the antenna beam pattern used during slot 3, i.e. beam 3. Simultaneously, the STA/responder directionally scans for the acknowledgement in the direction which it transmitted the beacon response, which in this case is beam 9.

Thereafter, the AP/initiator may proceed with transmitting and/or receiving data or other messages during a data period 320′, for the remainder of beacon interval 330′, including directional communications with STA/responder using the AP beam 3 and STA beam 9.

In another approach (not shown), the responder may complete a full scan cycle using all receive beams before responding. This contrasts with the approach of FIG. 4, where the responder truncates its scan cycle at the first beacon response period following its first receipt of a beacon. Completing a full scan cycle using all receive beams before responding allows the responder to respond using the best possible beam, which may not correspond to the beam on which the first received beacon was received. The initiator may specify which of these procedures it requires, and may signal the required procedure in the beacon.

Transmitting a beacon response in the direction of best received beacon transmission in this way can provide a more efficient starting point for fine beam training to converge on an overall best beam pair between the initiator and the responder.

In another possible implementation, the beacon response slots do not immediately follow the beacon transmission slots as described with respect to FIGS. 3 and 4, but rather are unpaired, and alternate with a data period in between.

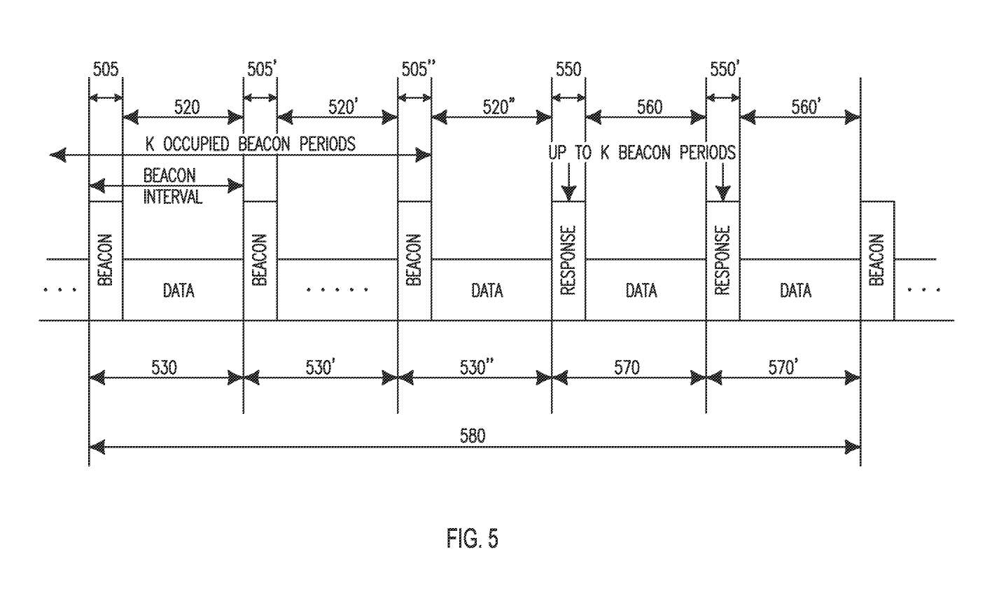

FIG. 5 illustrates a transmit-and-receive slot configuration for an initiator AP where the beacon transmission and response slots are unpaired.

In this example, beacon interval 530 includes a beacon period 505 and a data period 520.

During beacon period 505, the AP/initiator repeats directional beacon transmissions in M beacon slots (not shown), each covering a different direction. Thereafter, the AP/initiator may proceed with transmitting and/or receiving data or other messages during a data period 520, which in this example continues for the remainder of beacon interval 530. The AP/initiator then enters another beacon period 505′ and data period 520′, during another beacon interval 530′. This sequence repeats K times, with a period of one beacon interval, until a beacon response reception period is scheduled to occur. In this example, K=3, that is, there are three beacon intervals, 520, 520′, and 520″ before the scheduled beacon response reception period.

During beacon response reception period 550, the AP/initiator scans for responses to the beacon in each of M beacon response slots (not shown), which cover each direction of the M beacon slots respectively. Thereafter, the AP/initiator may proceed with transmitting and/or receiving data or other messages during a data period 560, which in this example continues for the remainder of beacon interval 570. This sequence may repeat up to K times (i.e. up to three times in this example), with a period of one beacon interval. In this example, there are two beacon intervals 570, 570′ having scheduled beacon response reception periods, 550 and 550′ respectively.

At the end of beacon interval 570′, the overall sequence of beacon intervals begins again. The length of this entire periodic sequence can be referred to as a super beacon interval 580.

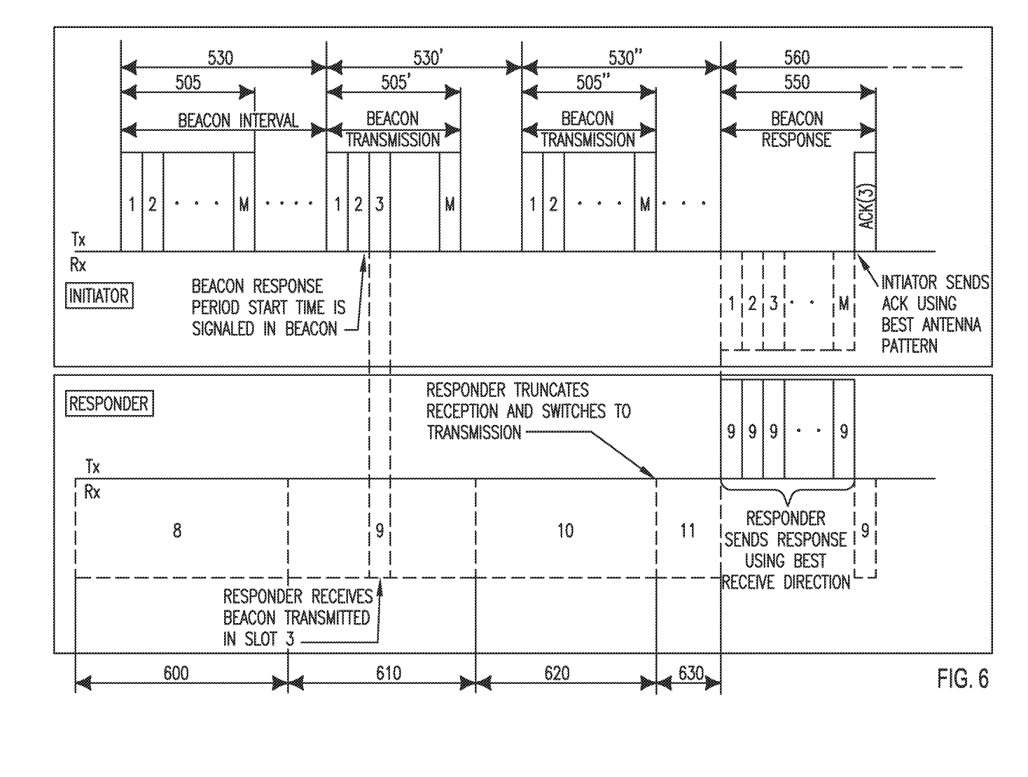

FIG. 6 illustrates an example frame structure for unpaired beacon transmission and response slots.

As discussed regarding FIG. 5, the AP/initiator repeats beacon transmissions in M slots during beacon transmission period 505, each covering a different direction. Thereafter, the AP/initiator may proceed with transmitting and/or receiving data or other messages during a data period 520, for the remainder of beacon interval 530. The AP/initiator then enters another beacon period 505′ and data period 520′, during another beacon interval 530′. This sequence repeats K times, (K=3 in this example) with a period of one beacon interval, until a beacon response reception period is scheduled to occur.

Independently of the AP/initiator, the STA/responder scans for beacons in a particular receive direction during scan interval 600. At this point, the AP/initiator and STA/responder are not synchronized. The STA/responder dwells in a particular receive direction for the duration of scan interval 600 (which equals the length of a BDSI as defined above) before switching its receive direction to a different beam.

In the example of FIG. 6, the STA/responder scans for beacons on beam 8 for the duration of scan interval 600. The STA/responder does not receive any beacons in the direction of beam 8 during scan interval 400, and proceeds to scan for beacons on beam 9 during the subsequent scan interval 610.

During scan interval 610, the STA/responder receives a beacon transmitted by the AP/initiator during its beacon transmission period 505′. The beacon contains information relating to the direction in which it was transmitted, (such as a beam identification number “3”) and a schedule identifying when the AP/initiator is scheduled to enter a beacon response period.

The STA/responder continues to scan for beacons on beam 9 during the remainder of scan interval 610, and does not immediately transmit a beacon response. After scan interval 610 has ended, the STA/responder proceeds to scan for beacons on beam 10 during scan interval 620, and then on beam 11 during scan interval 630.

In the example of FIG. 6, the AP/initiator is scheduled to enter a beacon response interval 550 during scan interval 630 of the STA/responder. Because the STA/responder has been appraised of this schedule in the received beacon, the STA/responder truncates scan interval 630 and its scan of beam 11, and begins transmitting a beacon response to the AP/initiator.

STA/responder transmits the beacon on beam 9 because the beacon was received on beam 9. In some implementations, if the STA/responder had received a beacon from more than one direction (i.e., more than one beam, not shown) prior to the start of the AP/initiator's beacon response interval 550, it would transmit the beacon response using the beam in the direction from which it received the highest quality beacon transmission (not shown).

Using unpaired beacon transmission and response slots, the initiator may send more beacons in a given time period, as compared to the paired transmission and response slots illustrated in FIGS. 3 and 4. This is because the entire beacon period of a given beacon interval is used for beacon transmissions, omitting the beacon response reception period for that beacon interval. This may occur for one or several beacon intervals, until a beacon response period is scheduled to occur. The schedule for the beacon response period may be included in the transmitted beacons, from which responders learn when to send their responses to the initiator to achieve slot synchronization.

In each beacon transmission period between successive beacon response periods, the initiator repeats the same sequence of beacon transmission directions. This same order of directions is used for response scanning in the following beacon response period. It is noted that this sequence may be split among several beacon response periods, following the same order as the beacon transmissions.

In implementations using unpaired beacon transmission and response slots, the responder will receive a successful beacon response within a time period of 2*K*(Beacon Directional Scan Interval) under ideal conditions and provided that it is within discovery range of a suitable initiator/AP. Here, K denotes the number of receive directions at the responder.

The discovery delay is proportional to the number of receive beams used by the responder to scan a region for beacons. By using a smaller number of broader beams to scan the region, device discovery is expedited but maximum discovery range suffers, due to broad beams. On the other hand, using a larger number of narrow beams to scan the same region increases the discovery range, but at the expense of discovery delay.

However, by using variable responder receive bandwidths; discovery range may be increased without incurring larger discovery times at shorter ranges.

Using variable responder receive bandwidths, the responder starts with a fairly wide beam (i.e., a small value of K). In the limiting case, K may equal 1, corresponding to an omnidirectional or pseudo-omnidirectional antenna pattern. As used herein, a pseudo-omnidirectional or quasi-omnidirectional antenna pattern refers to a directional antenna configured to transmit or receive omnidirectionally or with the widest attainable beam, and these terms may be used interchangeably herein. A quasi-omnidirectional antenna pattern may include a directional multi-gigabit (DMG) antenna operating mode with the widest beamwidth attainable. After completing a scan cycle of all K beams without receiving a beacon, the responder reduces the beamwidth and starts another scan cycle, with a larger number of receive directions (i.e., a larger value of K). The responder progressively decreases its beamwidth after each complete scan cycle where a beacon is not received.

Because of the increased number of narrower beams, each successive scan cycle takes longer to complete, but results in increase in discovery range. This allows the responder to be discovered quickly if it is near the initiator, while discovery rakes longer if it is far from the initiator. Moreover, this allows legacy 802.11ad devices to operate normally, using a single receive antenna pattern.

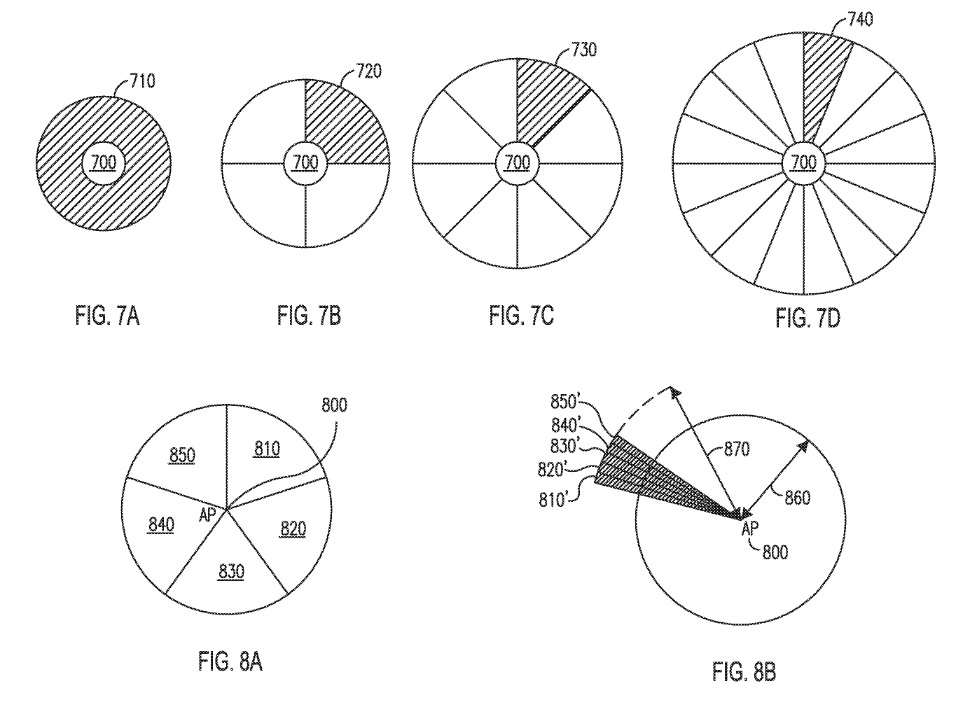

FIGS. 7A-D illustrate an example responder 700 using variable responder beamwidth discovery with an example sequence of progressively finer but more numerous receive beams.

In FIG. 7A, K=1, equivalent to the limiting case of an omnidirectional or quasi-omnidirectional receive pattern 710. In this example, if no AP/initiator beacon is received, the responder proceeds to the receive pattern of FIG. 7B.

In FIG. 7B, K=4. Here, range is increased by the use of a narrower beam 720. However, because the narrower beam 720 covers a smaller scan angle, 4 beacon scan intervals are necessary to cover the same area as covered in one scan interval by the receive pattern of FIG. 7A. Thus, the maximum discovery delay for an initiator within range is proportionally increased. If no AP/initiator beacon is received within 4 beacon scan intervals, the responder proceeds to the receive pattern of FIG. 7C.

In FIG. 7C, K=8. Here, range is further increased by the use of a still narrower beam 730. However, because the narrower beam covers a smaller scan angle than the beams 720 and 710 of FIGS. 7A and 7B, 8 beacon scan intervals are necessary to cover the same area as covered in one beacon scan interval using the pattern of FIG. 7A or 4 beacon scan intervals using the pattern of FIG. 7B. Thus, the maximum discovery delay for an initiator within range is proportionally increased. If no AP/initiator beacon is received within 4 beacon scan intervals, the responder proceeds to the receive pattern of FIG. 7D.

FIG. 7D show antenna patterns having yet further increased range and an even narrower beam pattern 740, with K=16. The discovery range and delay are each increased accordingly by progressing to this pattern from the pattern of FIG. 7C.

It will be understood that the particular antenna patterns, scanned regions, values for K, and progression of the variable responder beamwidth can be varied in order to optimize delay and range as desired.

Each beacon period may include three message types: the beacon transmitted by the initiator (i.e. beacon transmit message); the beacon response transmitted by the responding node (i.e. beacon response message); and the beacon response acknowledgement (ACK) that may be transmitted by the initiator. Any or all of these messages may be modified as desired to facilitate techniques described herein.

Such messages may carry device discovery related information. For example, the beacon transmit message may include the following fields:
Sector/Slot ID: Slot count or Sector ID for the current beacon transmission. This counter is reset at the start of each beacon period.
Max Sectors: Total number of beams (or slots) that the beacon transmitting node may transmit in the current transmission sequence.
Beacon Response Offset: Indicates in multiples of beacon intervals, time till the next beacon response period when the initiator listens for beacon responses. A value of zero may indicate that beacon response period may immediately follow the current beacon transmission sequence.

The beacon response message may include the following fields:
Tx sector/slot ID: Slot count or Sector ID for the current beacon response transmission.
Initiator sector/slot ID echo: Echo of the sector/slot ID received in the beacon message.
RSSI: Power of received beacon message.

The beacon response acknowledgement (ACK) message may include the following field:
Responder sector/slot ID echo: Echo of the sector/slot ID reported by the responder in the beacon response message.

It is noted that modifications may be made to the 802.11ad Medium Access Management Entity (MLME) Service Access Point (SAP) interface primitives to enable directional beacon reception and response reception procedures. For example, MLME-SCAN.request is a primitive that requests a survey of potential Basic Service Sets (BSSs) that the STA may elect to join. This primitive is generated by the Station Management Entity (SME) for a STA to determine if there are other BSSs that can be joined. Example MLME-SCAN.request primitive parameters for use in directional beacon reception and response reception may include the following:

MLME-SCAN.request(

BSSType,

BSSID,

SSID,

ScanType,

ProbeDelay,

ChannelList,

MinChannelTime,

MaxChannelTime,

RequestInformation,

SSID List,

ChannelUsage,

AccessNetworkType,

HESSID,

MeshID,

DiscoveryMode,

ScanDirections,

VendorSpecificlnfo)

This modified MLME-SCAN.request primitive includes a new parameter, “ScanDirections” which may have the characteristics shown in table 1:

TABLE 1

| | | Valid | |
|---|---|---|---|
| Name | Type | Range | Description |
| ScanDirections | Octet | 0-255 | The number and the sector IDs to |
| | string | octets | be used for beacon scanning. |
| | | | If a single integer is present, it |
| | | | refers to the number of scan |
| | | | directions to be used for beacon |
| | | | reception. The value 255 indicates |
| | | | scan request in all available scan |
| | | | directions. |
| | | | Presence of multiple values |
| | | | indicates the specific sector IDs in |
| | | | which beacon scanning is |
| | | | requested. |
| | | | The MinChannelTime and |
| | | | MaxChannelTime parameters |
| | | | refer to the total channel scan |
| | | | duration across all requested scan |
| | | | directions. |

Another primitive which may be modified is MLME-SCAN.confirm, which may be generated by the MLME in response to an MLME-SCAN.request primitive in order to ascertain the operating environment of the STA. The MLME-SCAN.confirm primitive returns descriptions of the set of BSSs detected by the scan process.

Example MLME-SCAN.confirm primitive parameters for use in directional beacon reception and response reception may include the following:

MLME-SCAN.confirm(

BS SDescriptionSet,

BS SDescriptionFromMeasurementPilotSet,

ResultCode,

ReceiveSectorID,

VendorSpecificlnfo)

This modified MLME-SCAN.request primitive includes a new parameter, “ReceiveSectorID” which may have the characteristics shown in table 2:

TABLE 2

| Name | Type | Valid Range | Description |
|---|---|---|---|
| ReceiveSectorID | Set of | A value of | The sector ID for beacon |
| | integers | 0-255 for each | reception corresponding to |
| | | member of set | each instance of |
| | | | BSSDescription. This |
| | | | indicates the sector through |
| | | | which strongest beacon |
| | | | reception was observed. |

Omnidirectional (OBand) band messages may be used in some implementations to assist long-range directional band (DBand) device discovery, and several modes of OBand assistance are described herein.

OBand in this case refers to license-exempt frequency bands that allow omnidirectional communications, such as 24 GHz, 5 GHz, TV White Space band, sub 1 GHz band, for example, although in some applications licensed frequency bands that allow omnidirectional communications may be used.

In the following examples, it is assumed that the STA/responder begins communications in the OBand, which may include OBand association with the initiator or simply pre-association beacon reception.

Omnidirectional band assistance for device discovery may include using OBand to provide initiator location information, responder location information, and/or beam training.

Using OBand communications to provide initiator location information, the initiator broadcasts its precise location information (obtained via GPS, Advanced GPS (AGPS), or other means) as part of an OBand beacon message. The responder begins operation on the OBand, and scans for OBand beacons from AP/initiators that also support DBand operations. As used herein, DBand includes the various directional discovery beacon, beacon response, and response acknowledgement techniques described herein. When the responder receives an OBand beacon from a DBand-capable AP/initiator which contains the AP's/initiator's location, the responder uses that information along with knowledge of its own location to estimate the direction in which the AP is located, relative to the responder. The responder then scans for DBand beacons in the direction of the AP with fine receive beams.

This initiator information provided via OBand by the initiator makes it possible for the responder to scan for DBand beacon transmissions from the initiator using a few narrow beams pointed in a specific direction instead of scanning all directions using wider beams or a greater number of narrow beams. This can have the advantage of increasing discovery range and/or decreasing discovery delay.

Using OBand to provide responder location information, the responder begins operations in the OBand, scanning for OBand beacons from DBand-capable devices. The responder sends its own precise location (obtained from GPS, AGPS, or other means) via OBand to DBand capable initiators. Upon receiving the STA/Responder's location via OBand, the AP/initiator uses that information, along with precise knowledge of its own location to estimate the direction in which the STA/Responder is located relative to the AP/initiator. The AP/initiator then alters its DBand beacon transmission sequence in the next DBand beacon transmission period and transmits DBand beacons using narrow beams in the estimated direction of the STA/Responder. This narrow beam beacon transmission is repeated for a determined number of beacon transmission periods while the STA/Responder scans for DBand beacons by cycling through its DBand receive directions.

The AP/initiator may also send its location to the STA/Responder via OBand message, so that the STA/Responder may also use narrow receive beams to scan for beacon transmissions. Beam patterns for the altered beacon transmission sequence are illustrated in FIGS. 8A and 8B.

FIG. 8A illustrates five wide-beam DBand beacon transmissions 810, 820, 830, 840, 850 by an AP/initiator 800, covering all directions from the AP/initiator 800. In FIG. 8A, the AP/initiator 800 does not have knowledge of the direction in which a DBand-capable STA/responder is located.

FIG. 8B illustrates five narrow-beam DBand beacon transmissions 810′, 820′, 830′, 840′, 850′ covering less than all of the total possible scanning directions from AP 800. In FIG. 8B, the AP/initiator 800 has received an OBand message (not shown) containing the location of a DBand-capable STA/responder, from which it can calculate the relative direction in which the STA/responder is located. Using this knowledge of the location of the STA/responder, the AP/initiator 800 uses narrower beams for beacon transmissions 810′, 820′, 830′, 840′, 850′. These narrower beams have a greater range 870 than the range 860 of the wide beams used for beacon transmissions 810, 820, 830, 840, 850 (shown in FIG. 8A).

The STA/Responder may also send the DBand-capable AP/initiator a report containing the measured signal strengths of all observed OBand beacons, via an OBand message. This aids the AP in estimating the STA/Responder location using historical information. The AP/initiator may then transmit focused beacons as described.

OBand may also be used to provide beam training feedback. For example, a STA/Responder may use an OBand message to indicate the directions from which it received a DBand beacon. Based on this feedback, the AP/initiator may scan only those directions for subsequent DBand beacon responses. This allows AP/initiator to use finer transmit beams for beacon transmissions, while scanning only a few directions for responses. This procedure may have the advantage of increasing discovery range and decreasing discovery delay.

Normally, the AP/initiator may be required to scan in all the transmit directions for beacon responses. However by using OBand feedback, the AP/initiator may scan a sub-set of the transmit directions.

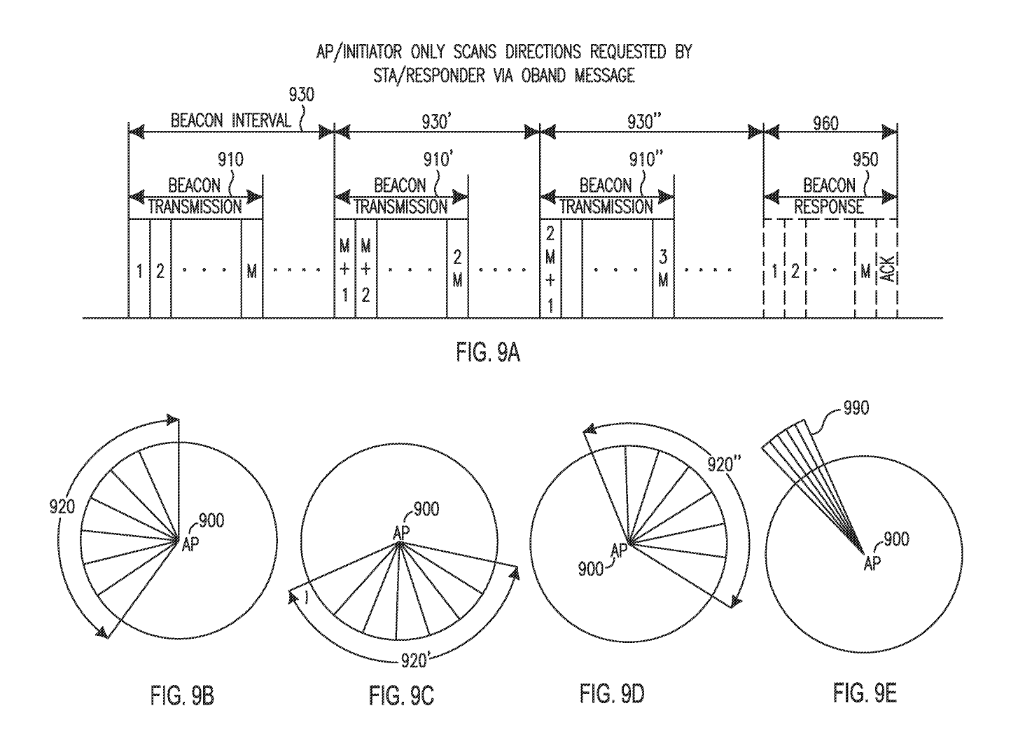

FIGS. 9A-9E illustrate an example frame structure and beams for this procedure.

The AP transmits beacons in N directions that are split over multiple beacon transmission periods, each containing M repetitions. FIG. 9B illustrates a first “super sector” 920 over which M beacon transmissions are transmitted in directions 1−M during beacon transmission period 910 of beacon interval 930. FIG. 9C illustrates a second “super sector” 920′ over which M beacon transmissions are transmitted in directions M+1−2M during beacon transmission period 910′ of beacon interval 930′. FIG. 9D illustrates a third “super sector” 920″ over which M beacon transmissions are transmitted in directions 2M+1−N (N=3M in this case).

Independently of the DBand beacon transmissions, the AP may receive an OBand message from a STA/responder which has received one or more of the directional beacons (not shown). The OBand message may contain information about the location of the STA/responder, and may be used by the AP/initiator to calculate the direction in which the STA/responder is located relative to the AP/initiator.

FIG. 9E illustrates narrow receive beams used to scan for a beacon response during beacon response period 950 of beacon interval 960. Here, the AP uses its knowledge of the direction in which the DBand capable STA/responder received a beacon. This can have the advantage of increasing the discovery range.

It is noted that bifurcated discovery and scheduling beacons may also be used to facilitate directional discovery.

The beacon currently specified in IEEE 802.11ad serves three purposes: device discovery, network synchronization and schedule distribution. The schedule element of the beacon may be quite large when the number of associated STAs is large. Additionally, since the beacons are repeated in multiple directions, beacon transmission may take a long time to complete. Moreover, repeating the transmission schedule of all STAs in all directions is redundant. Accordingly, the beacon may be split into two parts, which may be termed discovery beacons and scheduling beacons.

Discovery beacons may contain information to enable device discovery and are periodically transmitted in all supported directions. Scheduling beacons may be sent separately to associated STAs, each providing only the individual schedule for that STA.

Discovery beacon contents may be limited to elements that are essential for device discovery. The remaining information (including individual channel reservation schedules) may be sent separately to STAs that are already associated with the AP using the scheduling beacon, for example.

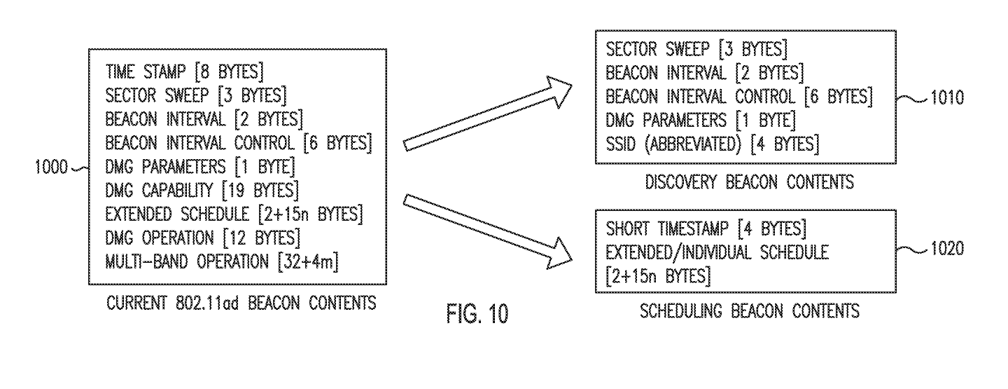

FIG. 10 illustrates the contents of a current IEEE 802.11ad beacon 1000, and the proposed contents of a discovery beacon 1010 and scheduling beacon 1020.

The shorter discovery beacon 1010 may be transmitted on a narrower channel than beacon 1000 to increase SNR. Alternately, the shorter discovery beacon 1010 may be more robustly encoded than beacon 1000, which may yield a longer range. Due to the reduced payload of the discovery beacon 1010, the discovery beacon 1010 may be encoded more robustly than the original beacon 1000, while maintaining the same transmission time. This may increase the device discovery range.

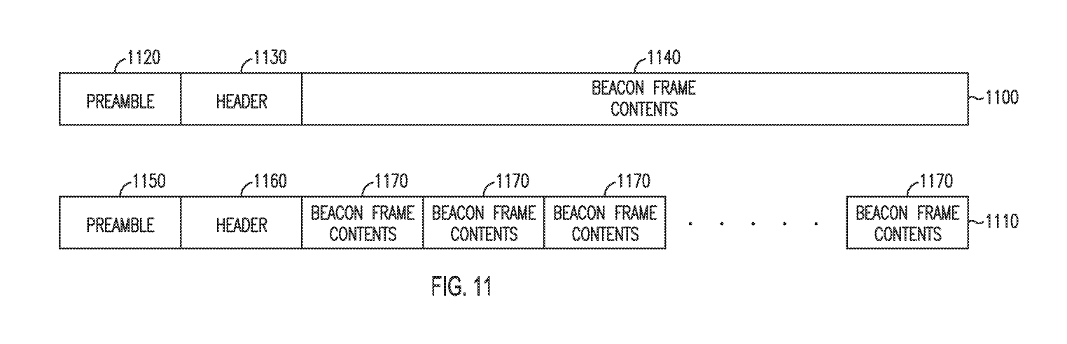

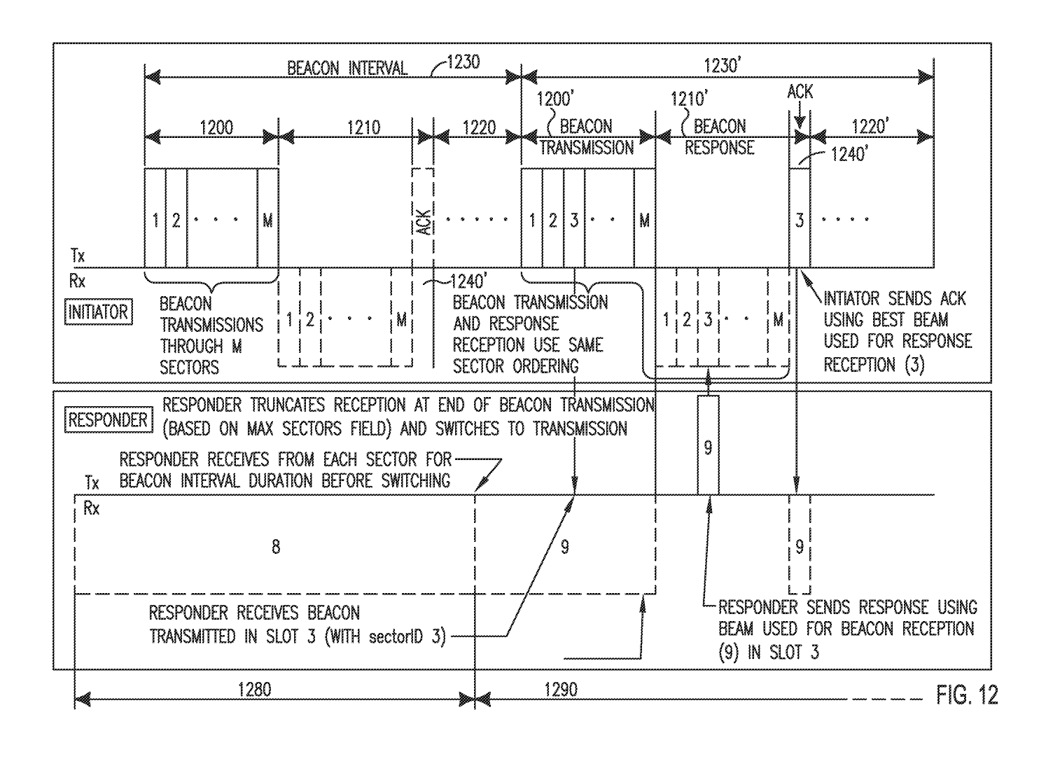

FIG. 11 illustrates the distribution of message contents 1100 in an original IEEE 802.11ad beacon 1000 (shown in FIG. 10) and the distribution of message contents 1110 in a discovery beacon 1010 (shown in FIG. 10). Message contents 1100 include a preamble 1120, header 1130, and beacon frame contents 1140. Message contents 1110 include a preamble 1150, header 1160, and beacon frame contents 1170.

Preamble 1120 and header 1130 may be of the same length as preamble 1150 and 1160 respectively. However, because beacon frame contents 1170 include less information than beacon frame contents 1140, the balance of the transmission time for beacon frame 1010 (shown in FIG. 10) can be used to repeat the beacon frame contents 1170 in a repetition encoding scheme, for example. However although FIG. 11 indicates repetition encoding of the discovery beacon contents, other coding options may also be employed using the remainder of the transmission time.

Further, the AP/initiator may use variable coding gain for beacons in different beacon intervals to trade off device discovery range against delay. For example, a higher proportion of beacon intervals with small coding gains and a lower proportion of beacon intervals with larger coding gains may be used in a super-cycle.

Since beacons encoded with larger coding gain require a longer transmission duration, and because the beacon transmission period per beacon interval is fixed, beacons encoded with large coding gain may be distributed over multiple beacon intervals to cover all supported directions. Therefore, in a super-cycle, beacons with small coding gain are repeated more frequently in a particular direction than those with larger coding gain.

Such time variation of the device discovery range via variable beacon coding gain may be useful in dense AP deployments. On average, an STA/Responder will receive beacons from a nearer AP/initiator earlier than those from farther Access Points (APs)/initiators and initiate association or beam training steps first with the nearer AP/initiator. The STA/Responder may then scan for a longer duration to receive beacons from APs/initiators located farther away and initiate further steps towards association with one or more of them to establish secondary links. These secondary links may be used when the primary link to AP/initiator is blocked or otherwise lost.

Furthermore, because the payload of the discovery beacon is reduced as compared to the present 802.11ad beacon, the discovery beacon may be transmitted in a narrower channel than the main data channel. This may result in an increased signal-to-noise ratio (SNR), which may increase the discovery range.

When a narrower channel is used to transmit discovery beacons, STAs/Responders may first scan for discovery beacons in this discovery channel. The discovery channel may be either in-band or out-of-band relative to the main data channel.

A long-range device discovery procedure may be used in a directional mesh architecture. Here, similar to the procedure described with respect to FIG. 4, APs transmit Beacons sequentially in multiple directions during a Beacon Transmission Interval (BTI). This is followed by an equal number of response slots, during which the AP switches over the same beam patterns, scanning for beacon responses from new nodes that received the beacons. The AP transmits beacons in M slots covering different directions. The new node scans for beacons in a particular receive direction, dwelling in a receive direction for a Beacon Directional Scan Interval (BDSI, as defined herein), before switching its receive beam.

Since the responder switches receive direction every Beacon Directional Scan Interval, the responder is assured of receiving a beacon in K*(Beacon Directional Scan Interval) duration, if within range of an appropriate AP/initiator for a particular combined transmit and receive antenna gain, under ideal conditions and where K is the number of receive beams used by the responder or new node.

The new node may not initially know the Beacon Directional Scan Interval value. Accordingly it may begin scanning for beacons with the smallest value for BDSI, which is obtained when Beacon Slot Recurrence Rate=1. Upon completing a full directional scan with this dwell time value without discovering an AP, it may increase the Beacon Slot Recurrence Rate to 2, re-scan all directions, etc. Upon reaching a reasonably large value for the Beacon Slot Recurrence Rate without receiving a beacon, the new node may switch to another channel, if available, and repeat the directional scanning procedure.

In an example implementations, the number of scan directions that can be accommodated in one beacon period is 22. For a 64-element patch array antenna having an approximately 10° broadside beamwidth, 7 beams are sufficient to cover a +/−45° range in azimuth for a single elevation angle. Therefore, 28 beams from four such antennas can provide complete 360° coverage. Based on the above formula, and assuming identical antennas having 64 elements each at both the new nodes and at the APs, a complete directional scan per elevation angle requires approximately 28 seconds. Accordingly, this is the maximum device discovery delay for the stated assumptions. However, a shorter device discovery delay may result when assistance information is provided by the first AP discovered by the new node. This node may be referred to as the primary node. The assistance information may include, for example, location information for the AP or other nodes, and may enable the new node to limit its scan to directions where other APs are expected to be found, as indicated by the primary node.

When the responder successfully receives a beacon, it truncates its current directional scan at the indicated time for the start of a beacon response period. The responder then sends the beacon response in the beacon response interval slot associated with the transmitter sector used to transmit the beacon message. It should be noted that that the initiator and the responder initially lack frame synchronization, which is achieved when the beacon is received by the responder/new node.

An example of this device discovery procedure is shown in FIG. 12. Here, the AP/initiator repeats beacon transmissions in M slots during beacon transmission period 1200, each using a different directional antenna beam pattern (beam) covering a different direction for transmission. During beacon response reception period 1210, the AP/initiator scans for responses to the beacon in each of the M slots, each using a directional antenna beam pattern covering a different direction for reception. The order of the beams used for reception during beacon response reception period 1210 is the same as the order of the beams used for transmission during beacon transmission period 1200. During response reception period 1210, an acknowledgement period 1240 is provided for transmitting an acknowledgement of any received beacon response, and thereafter the AP/initiator may proceed with transmitting and/or receiving data or other messages during a data period 1220, for the remainder of beacon interval 1230.

Because no beacon response was received by the AP/initiator during reception period 1210 in this example, no acknowledgement is transmitted by the AP/initiator during acknowledgement period 1240. Although acknowledgement period 1240 is illustrated as a part of beacon response period 1210, in the case where no beacon response is received, acknowledgement period 1240 may be used for other purposes and/or may be merged into data period 1220.

Independently of the AP/initiator, the station (STA)/Responder scans for beacons in a particular receive direction during scan interval 1280. At this time, the AP/initiator and STA/Responder are not synchronized. The STA/Responder dwells in a particular receive direction for the duration of a Beacon Directional Scan Interval (BDSI), before switching its receive beam to a different direction.

The STA/Responder scans for beacons in a particular direction, in this case using its beam designated as beam 8, for the duration of scan interval 1280. Scan interval 1280 equals one BDSI. The STA/Responder does not receive any beacons on beam 8 during scan interval 1280, and proceeds to scan for beacons on beam 9 during subsequent scan interval 1290. In this example, the STA/Responder receives a beacon from the AP/initiator while scanning beam 9 during scan interval 1290.

The received beacon was transmitted by the AP/initiator during its slot 3, and information identifying the beacon as having been transmitted during slot 3 (such as an identification of the time slot or beam used by the AP/initiator to transmit the beacon) may be provided to the STA/responder in the beacon.

In this example, the beacon contains information regarding the start time of beacon response period 1210′. At the start time of beacon response period 1210′, STA/responder truncates scan interval 1290 (unless the start time of beacon response period 310′ coincides with the end of scan interval 1290, in which case truncation is unnecessary) and sends a beacon response to the AP/initiator M times using an antenna beam in the direction in which the beacon was received, which in this case is direction “9” (i.e., beam 9).

Meanwhile, during beacon response reception period 1210′, the AP/initiator scans for responses to the beacon in each of the M slots.

The beacon response is received from the STA/responder during slot 3, when the AP/initiator is scanning in a direction in which it can receive the beacon response, i.e., with a beam pattern oriented sufficiently toward the STA/responder.

The AP/initiator may continue to scan the remaining slots during reception period 1210′, and in some implementations may receive additional responses from other responders during those slots (not shown).

Having received the beacon response during beacon reception period 1210′, the AP/initiator sends an acknowledgement to the STA/responder during acknowledgement period 1240′. The acknowledgement is sent directionally using the beam on which it received the response, which in this case is the antenna beam pattern used during slot 3, i.e. beam 3. Simultaneously, the STA/responder directionally scans for the acknowledgement in the direction which it transmitted the beacon response, which in this case is beam 9.

Thereafter, the AP/initiator may proceed with transmitting and/or receiving data or other messages during a data period 1220′, for the remainder of beacon interval 1230′, including directional communications with STA/responder using the AP beam 3 and STA beam 9.

When a new node completes a scan of all possible directions, depending on the configuration, the node may continue directional scanning in another available channel to discover available networks. The new node remains in the scanning phase until an AP is discovered.

Each beacon period includes three beacon message types. The first message is the beacon transmitted in the beacon transmission period (BTI) and is transmitted from an attached node (A→B) (i.e. beacon transmission message). Then, a response message in the beacon response reception period (BRI) may be transmitted from a responding node (B→A) to the attached node (i.e. beacon response message). Finally, a beacon response acknowledgement (ACK) may be transmitted from the attached node to the responding node (A→B). The messages may carry information as follows.

The beacon transmission message may include the following fields:
Network ID: Full or partial network ID including operator ID. A new node may use this in PLMN selection and filtering.
Node ID: ID of beacon transmitting node within the network.
Sector ID: ID of the beam being transmitted. Unique within the BTI, but non-unique between BTIs.
Max Sectors: Total number of sectors (or beams) that the beacon transmitting node may transmit to provide coverage over the sweep range.
Timestamp: Full or partial time information of the transmitted message to approximately 64 chip resolution. Used to measure air propagation time between message exchanging nodes.
Beacon Response Offset: Indicates the next available BRI during which the AP may listen for a new node's beacon response. The BRI immediately following the current BTI may not be available for new node response reception because it may have been previously reserved for association procedure with another new node or interference measurement.
BRI use code: Indicates the purpose for subsequent BRI. Valid codes include values indicating the following: available for new node beacon response (default), interference measurement, other new node association, etc.
Tx Power Info: Transmit power used for beacon transmission.
Control Slots: Number of control slots per control period.
FCS: Frame Check CRC sequence.

The beacon response message may include the following fields:
New node ID: MAC address of the responding node. The network checks its database for node capabilities and if the node can be admitted.
AP ID echo: Beacon transmitting node's ID is echoed back to check whether the transmitting and receiving nodes have mutually identified.
Timestamp echo: Beacon transmitting the node's Timestamp is echoed back so that air propagation time can be computed.
Gateway Indication: Intended to prevent a gateway node from directly connecting to another gateway node.
Additional capability class info: Configured capabilities not learnable from AP ID.
RSSI: Power of received beacon frame.
Delta Rx gain: Difference between Rx gain and Max Rx gain.
FCS: Frame Check CRC sequence.

The beacon response acknowledgement message (ACK) may include the following fields:
Rx node ID echo: MAC address of receiving node echoed back to ensure mutual node ID.
Hash of 48 bit address to 24 bits: generated via a suitable hash function.
Node ID: Responding node is given a node ID for this network. A node ID of 0 implies that the node is not accepted into the network. The following message fields, except FCS, are valid only if Node ID has a non-zero value:
Time Adjust: Offset to apply when transmitting to this network node.
Schedule: indicator of control slots the new node may initially listen to in link to this network node.
Channel: Used to indicate a channel for use in an initial schedule message exchange.
Power adjust for control messages: Power adjustment for subsequent control message transmission relative to beacon response message.
Configuration message: System information and new node configuration data (e.g., channel quality index (CQI) table definition).
Golay sequence indicator: Specifies a set of Golay sequences to use for Ga and Gb sequences. The Golay Sequence Indicator indicates what set the new node may use for its subsequent transmissions on this link.
FCS: Frame Check cyclic redundancy check (CRC) Sequence.

Device discovery error conditions may occur when no beacon response acknowledgement is received by the new node, when multiple simultaneous beacon transmissions occur with no collision, and when multiple simultaneous beacon transmissions occur with collisions.

The first case occurs when a new node sends a beacon response message upon receiving a beacon from an AP, but then does not receive a beacon response acknowledgement in return. The new node may wait until the next Beacon Transmission Interval to learn the cause for failure.

The new node may not have received an acknowledgement for one of two reasons.

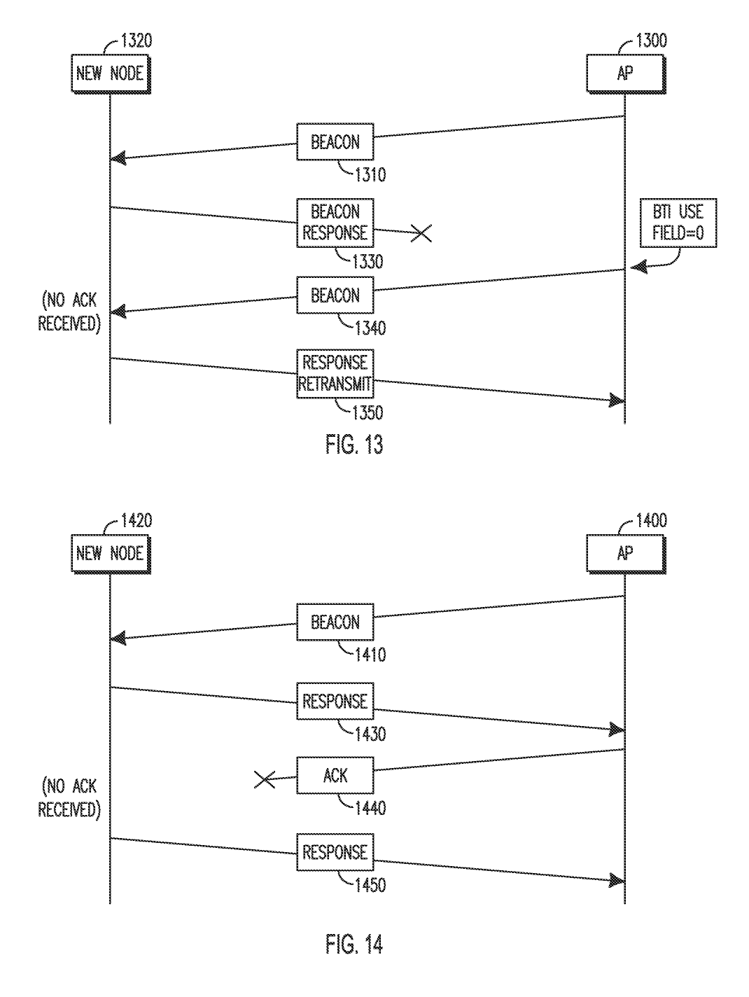

FIG. 13 is a message sequence chart illustrating the first possible reason, where the AP does not receive a transmitted beacon response message. In this case, AP 1300 transmits a beacon 1310 to new node 1320. New node 1320 transmits a beacon response 1330 to AP 1300, however AP 1300 may not have received the beacon response message 1330 from the new node 1320. In this case, the AP 1300 sets the value of the BRI use code field in the beacon message 1340 in the next BTI to 0, indicating that it is available for beacon responses. Upon receiving beacon 1340, the new node that had previously transmitted the beacon response 1330 understands from this use code that its beacon response 1330 was not correctly received by the AP 1300, and re-transmits a beacon response 1350 in the current beacon period, during BRI, using a different transmit antenna pattern.

FIG. 14 is a message sequence chart illustrating the second possible reason, where the new node does not receive a transmitted ACK from the AP. In this case, AP 1400 transmits a beacon 1410 which is received by new node 1420. New node 1420 transmits a beacon response to AP 1400, which receives the beacon response from new node 1400. AP then transmits a beacon response acknowledgement (ACK) message 1440, however the ACK message is not received correctly by the new node 1420. In this case, the new node 1420 re-transmits the beacon response 1450 in the current beacon period, during BRI, using the same transmit antenna pattern as before.

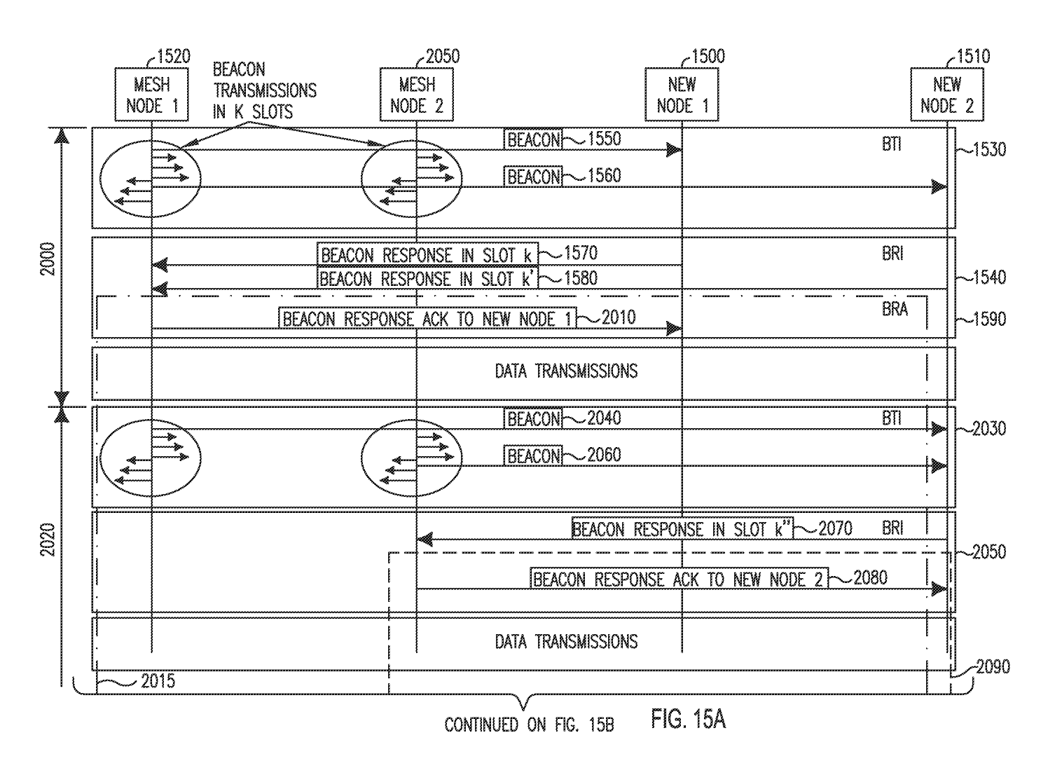

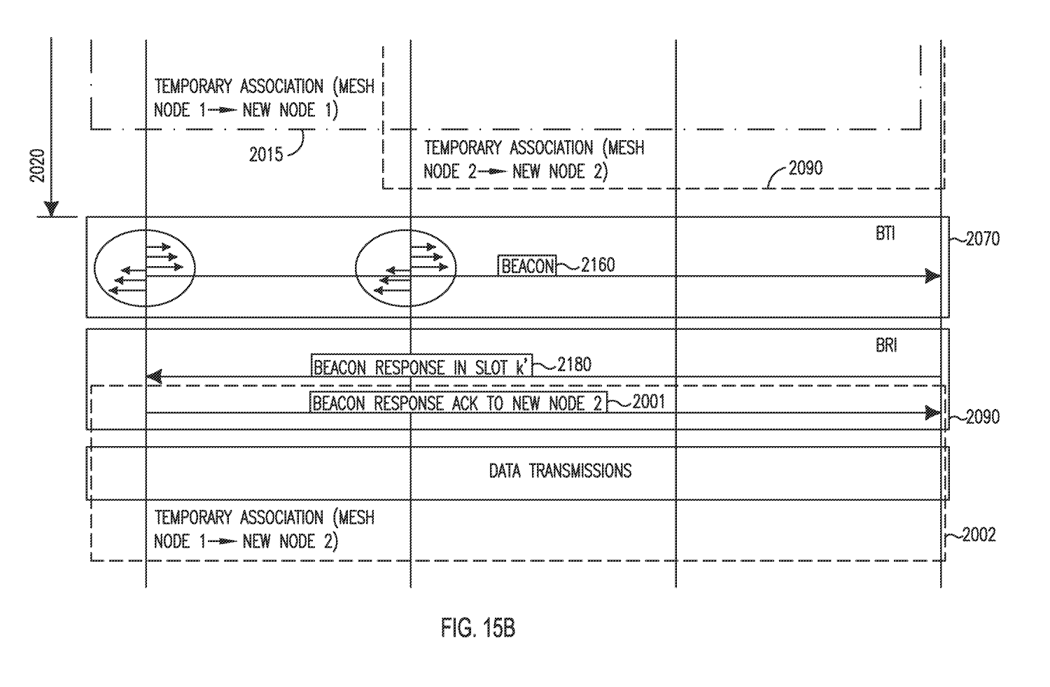

FIGS. 15A and 15B are a message sequence chart that illustrates the second case where the discovery procedure includes two nodes which respond in the same BRI without collision.

This case may occur when multiple new nodes 1500, 1510 have their receive antenna patterns pointed in the direction of a common AP 1520 during a BTI 1530, and each receive a beacon 1550, 1560 from AP 1520.

Each of new nodes 1500, 1510 may then transmit beacon responses 1570, 1580 during the following BRI 1540.

Multiple simultaneous beacon response transmissions 1570, 1580 occur with no collision because the new nodes 1500, 1510 are in different directions relative to the AP 1520, and as a result, respond in different slots during BRI 1540 without colliding.

However since there is only a single beacon response Acknowledgement (BRA) message slot 1590, the AP 1520 may only respond to one of them in the current beacon period 2000. Accordingly, the AP 1520 sends the BRA message 2010 to one of the new nodes, in this case new node 1500, by directionally transmitting in the direction of new node 1500. Data transmissions 2015 may then commence between AP 1520 and new node 1500.

The other new node 1510, which had also transmitted a beacon response 1580, does not receive BRA message 2010 (or identifies it as destined for a different node), and must wait until the next beacon period 2020 to learn the cause for discovery failure.

In beacon period 2020, during BTI 2030, the AP 1520 sets the BRI use code field (not shown) to 1 for transmitted Beacons, including beacon 2040 which is received by new node 1510. This indicates to new node 1510 (and any other receiving nodes) that the BRI 2050 may be used for a new node association procedure with a discovered new node, in this case, new node 1500.

The AP 1520 may also signal the duration of the current association process via the Beacon Response Offset field of beacons transmitted in BTI 2030. New nodes receiving the beacon message with non-zero value in the Beacon Response Offset field wait for the indicated number of beacon intervals before attempting to send a beacon response for discovery.

Thus, the new node 1510 which did not receive beacon response acknowledgement 2010 switches to the next beam in its scan cycle and does not wait for the discovered new node 1500 to complete its association process. Accordingly, new node 1510 can perform association with another AP in another direction simultaneously, in this case AP 2050. New node 1510 receives a beacon 2060 from AP 2050, transmits a beacon response 2070 to AP 2050, and receives acknowledgement 2080 from AP 2050. Data communications 2090 may then commence between new node 1510 and AP 2050.

After the number of beacon intervals specified in the beacon response offset field of the beacon received during BTI 2030, new node 1510 may receive a new beacon 2160 from AP 1520 during BTI 2070, respond with a beacon response 2180 during BRI 2090, and receive an acknowledgement message ACK 2001 from AP 1520. Thereafter, data transmissions 2002 may proceed between new node 1510 and AP 1520.

In the third case, multiple simultaneous beacon responses may collide which may occur when multiple new nodes have their receive antenna patterns pointed in the direction of a common AP during a BTI.

Each new node would then respond during the following BRI. Multiple simultaneous beacon responses occur with collision where the new nodes are in the same approximate direction relative to the AP, covered by the same transmit antenna pattern. As a result, such nodes respond in the same BRI slot, causing a collision of the responses.

The response collision may have several possible outcomes.

A first possibility is that the responses arrive at the AP at significantly different power levels, such that only one of the messages is successfully decoded by the AP. This possibility then reduces to the no collision condition described herein.

A second possibility is that none of the beacon response messages are successfully decoded by the AP. In this case, the AP may still identify that one or more new nodes responded in the BRI slot due to increased power level observed in that slot. Accordingly, in the next BTI the AP sets the BRI use code field to 0, and sets a non-zero value to the Discovered Node ID field. This indicates to the new nodes receiving the beacon that the previously transmitted beacon responses collided at the AP, requiring random back-off before re-attempting beacon response transmission. In an example random back-off, the new nodes may independently choose random numbers between 1 and a previously configured maximum value, and then wait for a number of Beacon Intervals equal to this value before re-attempting beacon response transmission. If the re-attempt again results in collision, then the initial maximum value may be doubled and a random number is chosen between 1 and the new maximum value. This procedure of doubling the maximum value and re-attempting beacon response transmission may be repeated a fixed number of times that is previously configured, before the new node abandons attempting to send beacon response to the AP.

A third possibility is that both beacon response messages are successfully decoded (resulting from the spreading and low code rate, for example, which may require a dual receiver).

A fourth possibility is that neither beacon response message is decoded, and the power level threshold for collision is not crossed. This reduces to the case described with respect to FIG. 13.

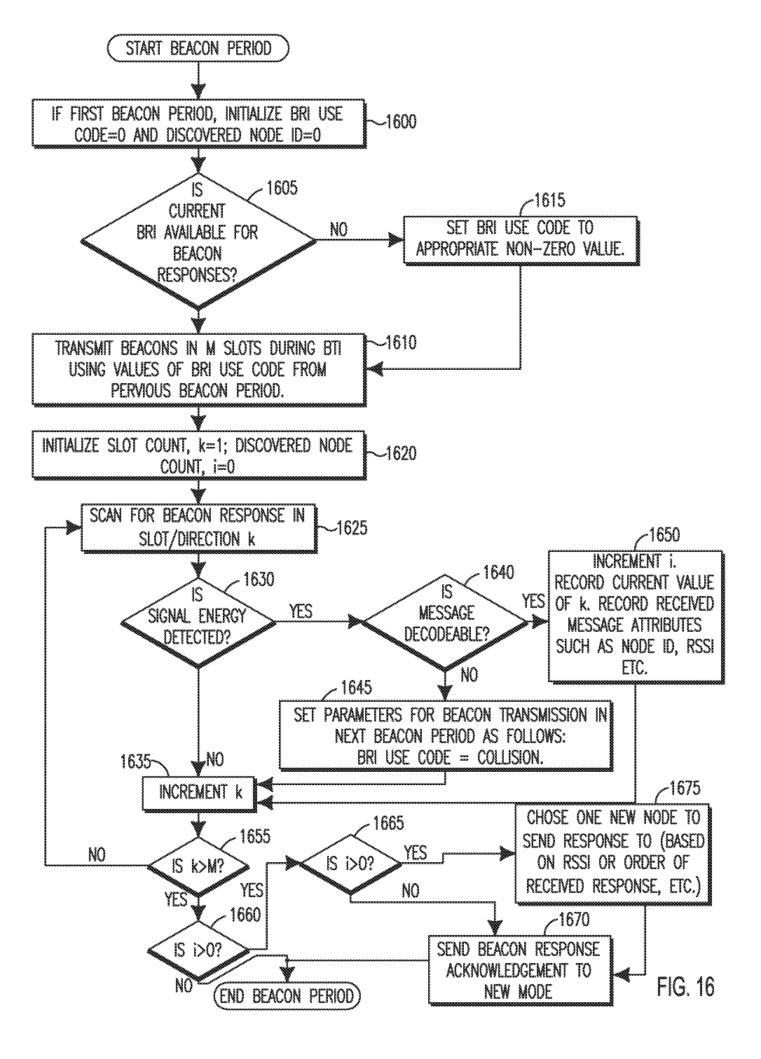

FIG. 16 is a flow-chart illustrating example device discovery phase procedures usable by an initiator/AP during a given beacon period according to techniques described herein. In this example, the initiator/AP is described as a mesh node; however it will be clear that these procedures may be used with other kinds of initiators.

In step 1600, if the beacon period is the first beacon period of operation of the mesh node, the use code and discovered node ID fields for transmitted beacon messages are initialized to 0.

In step 1605, it is determined whether the beacon response interval of the current beacon period is available for beacon responses. If the beacon response interval is available, the flow proceeds to step 1610. If the beacon response interval is not available, the flow proceeds to step 1615.

In step 1610, beacons are transmitted in M slots using a use code having the value from the previous beacon period.

In step 1615, the use code is set to an appropriate non-zero value for use in the transmissions during step 1610.

In step 1620, a slot count is initialized to k=1, and a discovered node count is initialized to i=0. The slot count k corresponds to a time slot k and direction k, where the mesh node scans a particular direction using a particular directional antenna pattern during that time slot.

In step 1625 the mesh node scans for a beacon response in the slot and direction corresponding to slot count k.

In step 1630 it is determined if signal energy is detected in the direction k during time slot k. If signal energy is detected, the flow proceeds to step 1640. If signal energy is not detected, the flow proceeds to step 1635.

In step 1635 k is incremented.

In step 1640 it is determined whether a decodable message is received in the direction k during time slot k. If a decodable message is received, the flow proceeds to step 1650. If a decodable message is not received, the flow proceeds to step 1645.

In step 1645 the use code for beacon messages transmitted in the next beacon period is set to a value indicating that a beacon response message collision was detected. The collision is deduced by the mesh node when signal energy is detected in slot k, but no decodable message is received in slot k.

In step 1650 the value of discovered node count i is incremented and the current value of k is recorded. Attributes in the received beacon response message, including Node ID, RSSI, and so forth, are also recorded.

In step 1655 it is determined whether slot count k is greater than M, the total number of slots. If the slot count k is greater than M, the flow proceeds to step 1660. If the slot count k is not greater than M, the flow proceeds to step 1625 where the mesh node continues to scan for a beacon response in slot k.

In step 1660, it is determined if i is greater than zero; in other words, whether a new node was detected during any of the M slots. If i is greater than zero, the flow proceeds to step 1665. If i is not greater than zero the beacon period ends.

In step 1665, it is determined if i is greater than 1; in other words, whether a beacon response was received from more than one new node. If i is greater than 1, the flow proceeds to step 1675. If i is not greater than 1, the flow proceeds to step 1670.

In step 1670, a beacon response acknowledgement is sent to the new node, and thereafter the beacon period ends.

In step 1675, the mesh node chooses one of the detected new nodes to which to send a beacon response acknowledgement. This choice may be made based on RSSI, order of received response, or otherwise. Thereafter, the flow proceeds to step 1670.

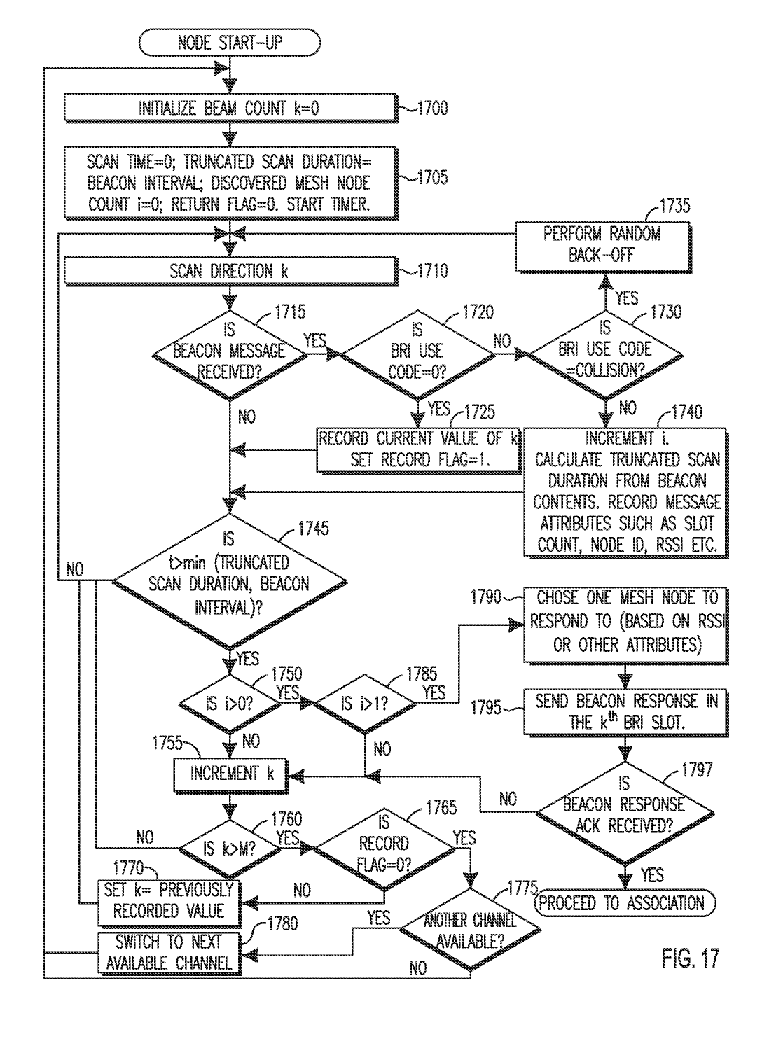

FIG. 17 is a flow chart illustrating example device discovery phase procedures usable at a new node according to techniques described herein.

After initial startup of the new node, in a step 1700 a beam count is initialized 1700 to k=0. In a step 1705 initialization of the following values is performed: scan time t=0, discovered mesh node count i=0, return flag=0, and truncated scan duration=beacon interval. A timer is also started during initialization.

In a step 1710 the new node directionally scans 1710 for beacons in direction k.

In a step 1715 it is determined whether a beacon message is received by the new node during the directional scan in direction k. If a beacon message is received, the flow proceeds to step 1720. If a beacon message is not received, the flow proceeds to step 1745.

In a step 1720 it is determined whether the beacon message contains a use code that is equal to zero. If the use code is equal to zero, the flow proceeds to step 1725. If the use code is not equal to zero, the flow proceeds to step 1730.

In a step 1725 the current value of k and a record flag value of 1 are recorded if the beacon message contains a use code that is equal to zero. The flow then proceeds to step 1745.

In a step 1730 it is determined whether the beacon message contains a use code that as a value indicating that the initiator detected a collision of beacon responses to a prior beacon. If the beacon message indicates a detected collision, the flow proceeds to step 1735. If the beacon message does not indicate a detected collision, the flow proceeds to step 1740.

In a step 1735 the new node performs a random back-off procedure if it is determined that the initiator detected a collision of beacon responses to a prior beacon. The flow then proceeds to step 1710.

In a step 1740 the discovered mesh node count i is incremented, contents of the beacon message (for example, slot count, node ID, RSSI, etc.) are recorded, and a truncated scan duration is calculated from the beacon message contents, if it is determined that the use code is not equal to zero and that the use code does not indicate that the indicator detected a collision of beacon responses to a prior beacon. The flow then proceeds to step 1745.

In a step 1745 it is determined whether the scan time t is greater than the lesser of either the truncated scan duration or the beacon interval, and if so, the flow proceeds to step 1750. If it is not, the flow proceeds to step 1710 where the new node continues to scan direction k.

In a step 1750, it is determined whether i is greater than 0. If i is greater than 0, the flow proceeds to step 1785. If i is not greater than zero, k is incremented in a step 1755.

In a step 1760 it is determined whether k is greater than M. If k is greater than M, the flow proceeds to step 1765. If k is not greater than M, the flow proceeds to step 1710 and the new node continues to scan direction k.

In a step 1765 it is determined whether the record flag is equal to zero. If the record flag equals zero, the flow proceeds to step 1770. If the record flag does not equal zero, the flow proceeds to step 1710 where the new node scans direction k.

In a step 1770 the value of k is set to the value recorded previously during step 1725, and the flow proceeds to step 1710 where the new node scans direction k.

In a step 1775, it is determined if another channel is available. If another channel is not available, the flow proceeds to step 1700 where the beam count is initialized to k=0. If another channel is available, flow proceeds to step 1780 where the new node switches to the next available channel before proceeding to step 1700.

In a step 1785, it is determined whether i is greater than 1, and if so, the flow proceeds to step 1790. If i is not greater than one, the flow proceeds to step 1755 where the new node increments step k.

In a step 1790, the new node chooses to which one of the mesh nodes, from which it has received a beacon, to respond. This choice may be based on RSSI or other attributes or considerations. The flow then proceeds to step 1795.

In a step 1795, the new node sends a beacon response message to the chosen mesh node during the kth slot in the mesh node's beacon response period. The flow then proceeds to step 1797.

In a step 1797, it is determined whether a beacon response acknowledgement message is received from the chosen mesh node, and if so, the new node and the chosen mesh node proceed to associate. Otherwise, the flow proceeds to step 1755.

Another approach for achieving increased discovery range includes device discovery using a pilot transmission.

Here, the initiator or AP transmits a discovery pilot sequence and repeats the pilot sequence in all supported directions for device discovery. This pilot sequence may either be common to all nodes, or each node may use a unique pilot sequence. As with beacon transmissions, this sequence is repeated in M different directions in M transmit slots.

In the meantime, independently of the AP/initiator, the responder or new node scans directionally, and maintains its scan direction for the duration of a beacon interval. It then switches to a new scan direction at the end of that period. At this point, the AP/initiator and the new node/responder are not synchronized.

While the new node/responder scans each direction for beacons, it employs energy detection to determine if signal energy is present. If while scanning in a particular direction the new node detects signal energy in one of the beacon transmission slots via energy detection, the new node terminates its scan and switches to transmit mode. Then, after waiting for a period equal to the Beacon Transmission Interval (BTI), the new node responds with a pilot sequence transmission using the same antenna beam through which beacon reception occurred.

The new node may repeat the response pilot sequence transmission multiple times with the same transmission beam, to facilitate successful reception by the initiator when its reception beam is pointed towards the new node. This indicates to the initiator or AP that a new node is within range. During a subsequent period, the new node may then initiate message transfer leading to node association or rejection, based on system configuration.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for device discovery in wireless communications, comprising:
scanning for a beacon using each beam of a plurality of antenna beams for reception;
on a condition that a beacon is received in a reception time slot using a beam of the plurality of antenna beams and based upon information contained in the beacon, truncating the scan; and,
transmitting a beacon response using the first beam during a transmission time slot corresponding to the reception time slot.

2. The method of claim 1, further comprising receiving a scheduling beacon which is different from the beacon.

3. The method of claim 2, further comprising transmitting the beacon response based upon information contained in the scheduling beacon.

4. The method of claim 1, wherein the beacon includes information regarding a direction from which the beacon is transmitted.

5. The method of claim 1, further comprising receiving information regarding a direction from which the beacon is transmitted, wherein the information is received using an omnidirectional antenna pattern.

6. The method of claim 5, further comprising directing the plurality of antenna beams toward the direction from which the beacon is transmitted based upon the information.

7. The method of claim 1, further comprising transmitting location information using an omnidirectional antenna pattern.

8. The method of claim 1, wherein a maximum range of the beacon response is at least equal to a maximum range of subsequent communications.

9. The method of claim 1, wherein the beacon is received using a narrower bandwidth than is used to receive subsequent communications.

10. The method of claim 1, wherein the beacon is transmitted directionally using a directional antenna.

11. A method for device discovery in wireless communications, comprising:
transmitting a beacon using each beam of a plurality of antenna beams, wherein the beacon contains information regarding a beacon response period;
scanning for a beacon response using each beam of the plurality of antenna beams and,
on a condition that a beacon response is received in a reception time slot of the beacon response period using a first beam of the plurality of antenna beams, transmitting an acknowledgement using the first beam of the plurality of antenna beams.

12. The method of claim 11, further comprising:
transmitting a scheduling beacon which is different from the beacon.

13. The method of claim 11, further comprising:
delaying transmission of a subsequent beacon after receiving the beacon response.

14. The method of claim 11, wherein the beacon response includes information regarding a direction from which the beacon response is transmitted.

15. The method of claim 11, further comprising receiving information regarding a direction from which the beacon response is transmitted, wherein the information is received using an omnidirectional antenna pattern.

16. The method of claim 15, further comprising:
directing the plurality of beams toward a direction from which the beacon response is transmitted based upon the information.

17. The method of claim 11, further comprising transmitting location information using an omnidirectional antenna pattern.

18. The method of claim 11, wherein a maximum range of the beacon is at least equal to a maximum range of subsequent communications.

19. The method of claim 11, wherein the beacon is transmitted using a narrower bandwidth than is used to receive subsequent communications.

20. The method of claim 11, wherein the beacon is received directionally using a directional antenna.
